(19) United States
(12) Patent Application Publication
(10) Pub. No.: US 2009/0205778 A1
(43) Pub. Date: Aug. 20, 2009

(54) Apparatus and Methods for Applying Labels

(75) Inventor: Franklin M. McCorkle, Concord, NC (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/261,671

(22) Filed: Oct. 30, 2008

Related U.S. Application Data
(60) Provisional application No. 61/029,461, filed on Feb. 18, 2008.

(51) Int. Cl. B29C 65/52; B65C 9/26; B05D 3/12

(52) U.S. Cl. 156/285; 118/50; 156/538; 156/578; 427/207.1

(57) ABSTRACT

An apparatus for applying labels to moving articles includes a vacuum drum mounted for rotation about a central axis and a manifold having a first passage adapted to be in fluid communication with a first vacuum line. First apertures in the vacuum drum are in communication with the first passage of the manifold such that vacuum pressure may be developed at the first apertures to hold labels on selected portions of the vacuum drum. Second apertures in the vacuum drum are adapted to be in communication with a second vacuum line. The second apertures are positioned for location behind the trailing edges of labels held by the first apertures so that excess adhesive applied to the labels may be removed through the second apertures.

### CROSS-REFERENCE

This application claims priority to pending U.S. Provisional Patent Application No. 61/029,461, filed Feb. 18, 2008 (pending), which is incorporated by reference herein in its entirety.

### TECHNICAL FIELD

The present invention relates generally to the application of adhesive to substrates, and more particularly to the application of adhesive to labels.

### BACKGROUND

Labels may be made in various sizes and shapes, and may be one of several types. One type of label, for example, is the wrap-around label, in which a leading edge of the label is initially secured with adhesive to a three dimensional object, such as a container or other product or product packaging of any shape. The label is then wrapped around the object so that the trailing edge of the label overlaps and is adhesively secured to itself. Another type of label is one in which both the leading and trailing edges of the label are affixed directly to the object.

The securement of labels to bottles or other containers, for example, must be of such a quality that the labels can withstand the various conditions that may be later experienced by the containers or bottles during shipping, storage, and use thereof, subsequent to the product packaging or filling operation. For example, labels that are applied to bottles of carbonated beverages must withstand expansion of the bottles due to the carbonation of the beverage, and additional expansion and contraction during shipping and storage operations in which the temperatures of the product may vary. Moreover, the labels must also be aesthetically pleasing. For example, it may be desired that the exposed edge of a label does not readily flap loosely away from the product, become detached from the product, have exposed adhesive, or have large amounts of adhesive forming lumps underneath the label.

In conventional processes, adhesive is applied to labels or other flexible substrates using a wheel coater. Wheel coaters typically use an open reservoir for holding the adhesive. A rotating wheel receives a coating of adhesive on its outer circumference and then transfers the adhesive onto a label or other flexible substrate by rolling contact. A container, such as a bottle, can, or other type of object moves along a conveyor and a paper or plastic label is secured to the outer surface of the container or object during a production operation. One drawback of wheel applied adhesive is that the open reservoir is susceptible to contamination, which may affect the quality of applied labels.

Other known processes may involve the application of adhesive via one or more non-contact adhesive dispensers that direct adhesive to the back surface of labels that are mounted on the circumferential surface of a rotating drum. In processes of this type, the back surfaces of the labels typically face outwardly and toward the non-contact adhesive dispenser. In some applications, use of conventional non-contact adhesive dispensers may cause residual adhesive that did not get applied to the label after shut-off to be pulled along by the rotating drum. This residual adhesive may be sucked into vacuum ports that hold the labels on the drum, or may become deposited on other parts of the labels, thereby affecting the quality of the resulting adhesive pattern on the label or the production process. This phenomenon, commonly referred to as “stringing” or the formation of “angel hair,” may occur in various other applications where the viscous and elastic nature of material such as hot melt adhesive may facilitate the formation of such residual adhesive. Accordingly, there has been a long-felt need to address the effects caused by the stringing of residual adhesive in labeling and other applications.

Other labeling processes may involve the application of adhesive to labels using slot coaters that come into contact with the labels. In such processes, it may be necessary to repeatedly retract the slot coater away from the rotating drum, or to retract the rotating drum away from the slot coater, particularly when adhesive is not being applied to a label. Retraction of the slot coater or drum may be done, for example, to prevent the transfer of heat from the slot coater to portions of the label onto which adhesive is not applied. Retraction of the slot coater or drum may require complex mechanical components and associated controls which may increase maintenance and/or production costs.

There is a need for apparatus and methods of applying adhesive to labels and other flexible substrates that overcomes these and other drawbacks of conventional adhesive application devices.

### SUMMARY

In one aspect, an apparatus for applying labels to moving articles includes a vacuum drum mounted for rotation about a central axis and a manifold plate having a first passage adapted to be in fluid communication with a first vacuum line. A plurality of first apertures on a first peripheral surface portion of the vacuum drum is in fluid communication with the first passage of the manifold plate so that the first peripheral surface portion can receive and support labels thereon. The apparatus further includes at least one second aperture on a second peripheral surface portion of the vacuum drum. The second peripheral surface portion is adjacent the first peripheral surface portion and defines a location behind a trailing edge of a label received on the first peripheral surface portion. The second aperture is in fluid communication with a second vacuum line to thereby remove excess adhesive applied to a label.

In another aspect, a method of dispensing adhesive to a label includes receiving a label on a vacuum drum, supporting the label on the vacuum drum using vacuum pressure associated with a first vacuum line, dispensing adhesive to the label, and removing excess adhesive using vacuum pressure associated with a second vacuum line.

In one embodiment, the first vacuum line is associated with a first vacuum source and the second vacuum line is associated with a second vacuum source that is independent of the first vacuum source.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention.

FIG. 1 is a schematic plan view illustrating an exemplary apparatus for applying labels to moving objects.

FIG. 2 is a perspective view of an exemplary vacuum drum assembly of the apparatus of FIG. 1.

FIG. 3 is an exploded perspective view of the vacuum drum assembly of FIG. 2.

FIG. 4 is a partial cross-sectional view of the vacuum drum assembly of FIG. 1, taken along line 4-4.

FIG. 5 is a partial cross-sectional view of the vacuum drum assembly of FIG. 1, taken along line 5-5.

FIG. 6 is a schematic plan view, similar to FIG. 1, illustrating another exemplary apparatus for applying labels to moving objects.

FIG. 7 is a partial cross-sectional view another exemplary vacuum drum assembly, similar to the cross-sectional view of FIG. 4.

FIG. 8 is a partial cross-sectional view the exemplary vacuum drum assembly of FIG. 7, similar to the cross-sectional view of FIG. 5.

### DETAILED DESCRIPTION

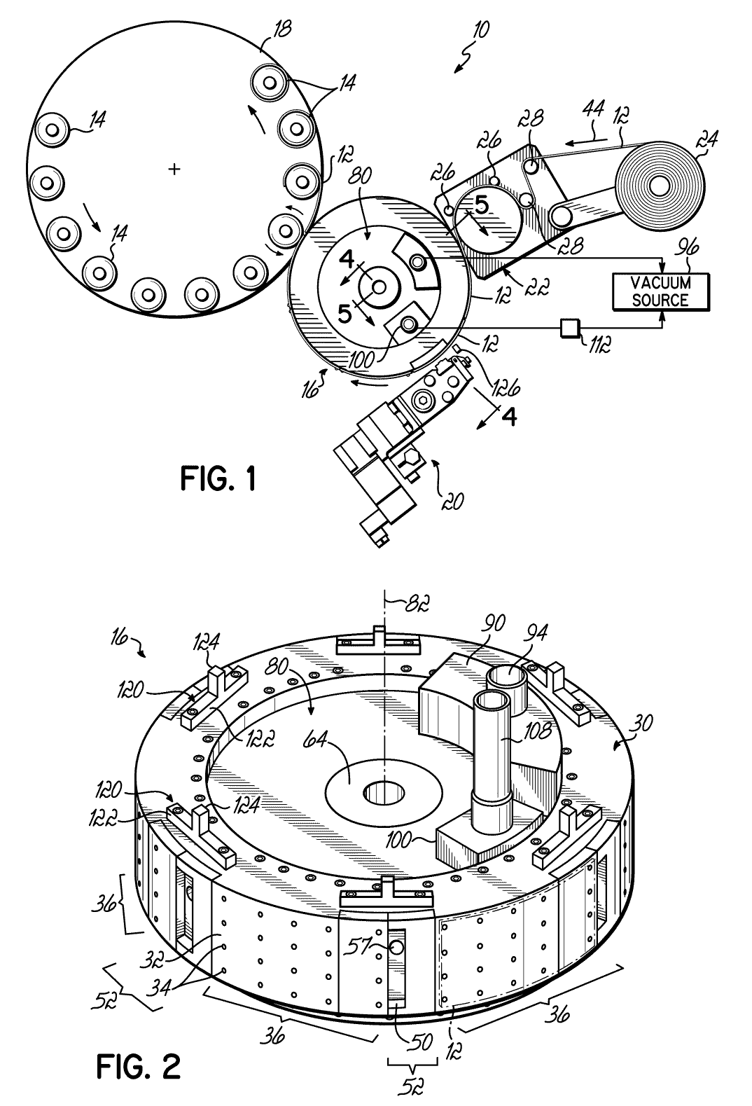

FIG. 1 depicts an exemplary apparatus 10 for applying labels 12 to moving containers 14 or other objects, in accordance with the principles of the present disclosure. The apparatus 10 includes a vacuum drum assembly 16 for receiving and supporting labels 12 on an outer circumference thereof and for transferring the labels 12 to containers 14 carried on a conveyor 18 adjacent the vacuum drum assembly 16. In the embodiment shown, the conveyor 18 is a rotating carousel that directs individual containers 14 past the vacuum drum assembly 16. The apparatus 10 further includes at least one adhesive dispensing gun 20 positioned adjacent the vacuum drum assembly 16 for applying adhesive to labels 12 supported on the vacuum drum assembly 16 prior to the transfer of labels 12 to containers 14 on the conveyor 18. In one embodiment, the adhesive dispensing gun 20 is configured to dispense adhesive to the labels 12 without contacting the labels 12.

After the dispensing gun 20 applies adhesive to the labels 12, the labels 12 are applied to the containers 14 that are directed past the vacuum drum assembly 16 by the conveyor 18. The conveyor 18 is positioned relative to the vacuum drum assembly 16 so that the containers 14 will come into contact with the labels 12 after the adhesive is applied. To facilitate applying the labels 12, the containers 14 may be rotated in a direction opposite the rotation of the vacuum drum assembly 16. While the conveyor 18 shown and described herein is a rotating carousel, it will be appreciated that various other types of conveying devices suitable for moving containers 14 past the rotating vacuum drum assembly 16 may alternatively be used.

The apparatus 10 also includes a label feed device 22 for supplying labels 12 to the vacuum drum assembly 16. In the embodiment shown, the label feed device 22 is adapted to receive labels 12 in the form of a roll 24 and to direct the labels 12 to the surface of the vacuum drum assembly 16. The labels 12 may be carried by the vacuum drum assembly 16 as a continuous web, or they may be cut from the roll 24 while on the vacuum drum assembly 16 or prior to being transferred to the vacuum drum assembly 16. The label feed device 22 may include capstans 26 and/or drive rollers 28 to direct the labels 12 from the roll 24 to the surface of the vacuum drum assembly 16.

While a label feed device 22 has been shown and described herein as being adapted to receive and deliver labels 12 to the vacuum drum assembly 16 from a roll 24, it will be appreciated that various other label feed devices may alternatively be used. For example, an alternative label feed device may include a magazine for feeding a stack of precut labels 12 to the vacuum drum assembly 16.

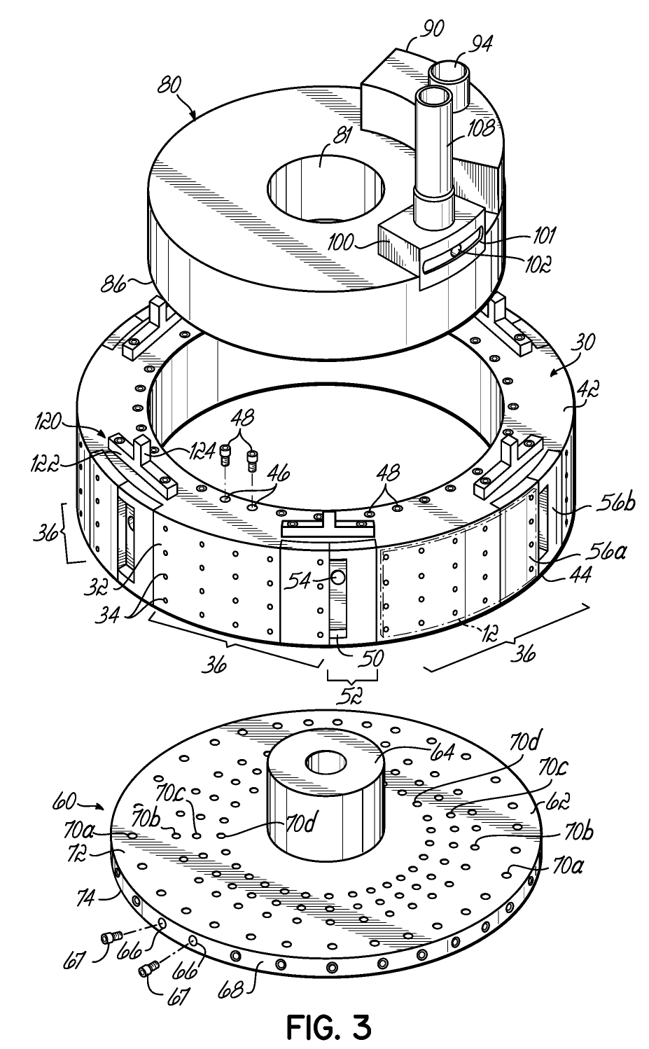

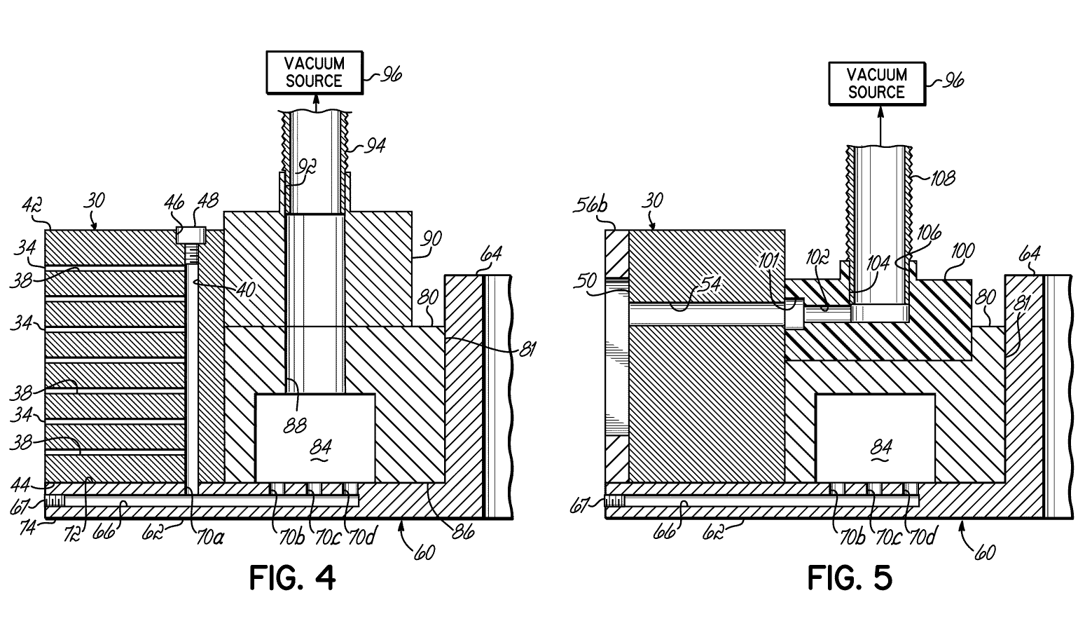

With continued reference to FIG. 1, and referring further to FIGS. 2 and 3, the vacuum drum assembly 16 comprises a generally cylindrical drum body 30 having an outer peripheral surface 32 with a plurality of first apertures 34 arranged to provide vacuum pressure at locations for supporting labels 12 on the outer peripheral surface 32. The first apertures 34 are spaced generally uniformly around the outer peripheral surface 32 to define first peripheral surface portions 36 for supporting respective labels 12. Each first aperture 34 communicates with a generally radially extending passage 38 through the drum body 30, as depicted in FIG. 4. The drum body 30 further includes vertical passages 40 extending through the cylindrical drum body 30 between first and second axial ends 42, 44 of the drum body 30. Each of the radially extending passages 38 communicates with a vertical passage 40. The vertical passages 40 are open at the first and second axial ends 42, 44 of the drum body 30, and the opening 46 at the first axial end 42 may be sealed with a closure 48, such as a cap screw or any other suitable structure.

When the adhesive dispensing gun 20 is a non-contact type dispensing gun that can dispense adhesive to labels 12 without contacting the labels 12, the drum body 30 can be made with a uniform outer peripheral surface 32. In contrast, conventional vacuum drums used for labeling applications wherein adhesive is applied by a wheel coater typically have raised surfaces, or lands, located around the outer peripheral surface of the drums to define contact areas between the leading and training edges of a label and the wheel coater. Because a drum body 30 in accordance with the present disclosure does not require such raised surfaces, the drum body 30 is easier to manufacture and service.

The cylindrical drum body 30 further includes second apertures 50 provided on second peripheral surface portions 52 of the drum body 30 that are located adjacent the first peripheral surface portions 36. The second peripheral surface portions 52 define locations behind the trailing edges of labels 12 received on the first peripheral surface portions 36 of the drum body 30. Accordingly, the outer peripheral surface 32 is divided into an alternating series of first and second peripheral surface portions 36, 52. In the embodiment shown, the second apertures 50 are in the form of elongate slots extending axially along the drum body 30, but it will be appreciated that the second apertures 50 may alternatively have various other configurations. The second apertures 50 communicate with passages 54 extending radially through the drum body 30, as depicted in FIG. 5. In contrast to the passages 38 communicating with the first apertures 34 on the drum body 30, the passages 54 communicating with the second apertures 50 extend fully through the drum body 30.

In the embodiment shown, the outer peripheral surface 32 of the drum body 30 is partially defined by first and second surface blocks 56a, 56b secured to the drum body 30 proximate the boundary of the first and second peripheral surface portions 36, 52. This arrangement may be suitable for converting a conventional vacuum drum having raised lands for use with a wheel coater into a vacuum drum assembly 10 as shown and described herein. It will be appreciated, however, that the drum body 30 may alternatively be formed from to have a constant diameter outer peripheral surface 32 without the use of surface blocks 56a, 56b.

With continued reference to FIGS. 2-3, and referring to FIGS. 4-5, the vacuum drum assembly 16 further includes a manifold plate 60 secured to the second axial end 44 of the drum body 30. In the embodiment shown, the manifold plate 60 comprises a generally circular disk 62 having a generally cylindrically-shaped hub 64 extending axially from a central portion of the disk 62. A plurality of radially extending bores 66 are formed through the disk 62 from an outer circumferential surface 68 in a direction toward the hub 64, as depicted in FIGS. 4 and 5. The manifold plate 60 further includes a plurality of axial bores 70a, 70b, 70c, 70d formed in the disk 62 from a first axial end 72 of the disk 62 in a direction toward a second axial end 74 of the disk 62. The axial bores 70a, 70b, 70c, 70d are arranged in groups defining concentric circles centered about the hub 64. Each axial bore 70a, 70b, 70c, 70d is aligned along a radius of the disk 62 and communicates with one of the radially extending bores 66, as depicted in FIGS. 4 and 5.

When the manifold plate 60 is coupled to the drum body 30, the vertical passages 40 in the drum body 30 are aligned with one of the radially outermost axial bores 70a in the manifold plate 60 such that there is fluid communication between each vertically extending passage 40 and one of the radially extending bores 66, whereby fluid flow is permitted between the first apertures 34 on the drum body 30 through the radial and vertical passages 38, 40 of the drum body 30, through the radially outermost axial bores 70a, through the radially extending bores 66, and to the radially interior axial bores 70b, 70c, 70d, as depicted in FIG. 4.

With continued reference to FIGS. 2-5, the vacuum drum assembly 16 further includes an inner manifold 80 received within the inner diameter of the drum body 30 and contacting the first axial end 72 of the manifold plate 60. The inner manifold 80 has a central aperture 81 that is sized to receive the hub 64 of the manifold plate 60 in an assembled condition of the vacuum drum assembly 16. Sufficient clearance is provided between the inner diameter of the drum body 30 and the outer diameter of the inner manifold 80 so that the drum body 30 and manifold plate 60 may rotate about a central axis 82 while the inner manifold 80 is held in a fixed position by supporting structure (not shown). A cavity 84 is formed in a lower surface 86 of the inner manifold 80 and is positioned so that the cavity 84 communicates with the radially interior axial bores 70b, 70c, 70d of the manifold plate 60 when the inner manifold 80 is positioned in contact with the manifold plate 60, as depicted in FIG. 4. The cavity 84 may extend circumferentially around the inner manifold 80 to provide fluid communication with the radially interior axial bores 70b, 70c, 70d of the manifold plate 60, as may be desired. An axially extending passage 88 is formed through the inner manifold 80 and communicates with the cavity 84. The interface between the manifold plate 60 and the inner manifold 80 may be sealed with grease or any other material suitable to seal fluid flow between the manifold plate 60 and the inner manifold 80 while the manifold plate 60 and drum body 30 rotate relative to the inner manifold 80.

The vacuum drum assembly 16 further includes a first vacuum housing 90 coupled to the inner manifold 80 proximate the axially extending passage 88. The first vacuum housing 90 includes an outlet 92 adapted to be coupled to a first conduit 94 that is in communication with a vacuum source 96. When vacuum pressure is applied from the vacuum source 96 through the conduit 94, air is drawn through the plurality of first apertures 34 on the drum body 30 via the various passages and bores 38, 40, 70a, 66, 70b, 70c, 70d, as described above, and through the cavity 84 and passage 88 of the inner manifold 80 so that a label 12 applied to the first peripheral portions 36 of the drum body 30 may be held thereon by vacuum pressure.

The vacuum drum assembly 16 further includes a second vacuum housing 100 coupled to the inner manifold 80. The second vacuum housing 100 includes an outer aperture 101 communicating with a radially extending passage 102. In the embodiment shown, the outer aperture 101 is a slot extending generally in a circumferential direction of the inner manifold 80, however, aperture 101 may alternatively have various other configurations. Outer aperture 101 and radially extending passage 102 are positioned for sequential registration with the second radial passages 54 through the drum body 30 as the drum body 30 rotates relative to the inner manifold 80 and the second vacuum housing 100. The radially extending passage 102 through the second vacuum housing 100 communicates with a vertically extending passage 104 and a second outlet 106 adapted to be coupled to a second conduit 108 that is in fluid communication with the vacuum source 96.

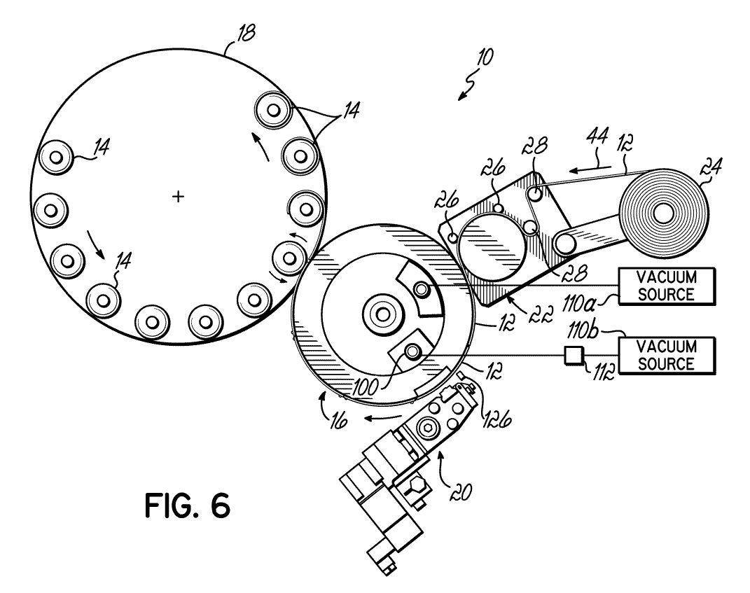

While the first and second vacuum housings 90, 100 are shown and described herein as being in fluid communication with a common vacuum source 96, it will be appreciated that the first and second vacuum housings 90, 100 may alternatively be in fluid communication with separate vacuum sources 110a, 110b, as schematically depicted in FIG. 6. A filter 112 may be provided between the second vacuum housing 100 and vacuum source 110b.

In use, the drum body 30 and manifold plate 60 rotate about a central axis 82 while the inner manifold 80 and the first and second vacuum housings 90, 100 are held in a fixed position relative to the rotating drum body 30 and manifold plate 60. Vacuum pressure is developed at the first apertures 34 by communication with the vacuum source 96 through the passages 38, 40 in the drum body 30 and the bores 66, 70a, 70b, 70c, 70d in the manifold plate 60 which communicate with the cavity 84 in the inner manifold 80. Accordingly, vacuum pressure is provided at the first apertures 34 while the drum body 30 is rotating to receive labels 12 on the first peripheral surface portions 36. As the labels 12 are rotated past the adhesive dispensing gun 20 by the vacuum drum assembly 16, adhesive is dispensed to selected portions of the labels 12. The second vacuum housing 100 is positioned such that the aperture 101 and radial passage 102 through the second vacuum housing 100 align in registration with a radial passage 54 through the drum body 30 as the trailing edge of a label 12 receives adhesive from the adhesive dispensing gun 20. At that moment, vacuum pressure is provided to the second aperture 50, such that any residual adhesive not applied to the label 12 and forming a string of adhesive behind the label 12 will be drawn into the second aperture 50 and removed through the drum body 30 and second vacuum housing 100. A filter 112 may be provided between the second vacuum housing 100 and the vacuum source 96 to collect the excess adhesive. Accordingly, the vacuum pressure provided to first apertures 34 and used to hold labels 12 on the first peripheral surface portions 36 of the drum body 30 is isolated from the vacuum pressure provided to second apertures 50 for removing residual adhesive.

To facilitate dispensing adhesive to labels 12 supported on the rotating vacuum drum assembly 16, the vacuum drum assembly 16 may further include at least one sensor target 120 for indicating the location of a label 12 on the drum body 30. In the embodiment shown, the sensor target 120 comprises a block 122 secured to the first axial end 42 of the drum body 30 and positioned proximate the interface of the first and second peripheral surface portions 36, 52 of the drum body 30. The block 122 includes an upwardly extending protrusion 124. The sensor target 120 may be detected by a sensor 126 positioned near the vacuum drum assembly 16 to indicate the location of a feature of a label 12, such as the trailing edge of a label 12, as the label 12 is carried past the adhesive dispensing gun 20 by the rotating vacuum drum assembly 16. While the sensor target 120 has been shown and described herein as a block 122 secured to a first axial end 42 of the drum body 30, it will be appreciated that various other types of sensor targets suitable to indicate the location of a label 12 on the rotating vacuum drum assembly 16 may alternatively be used.

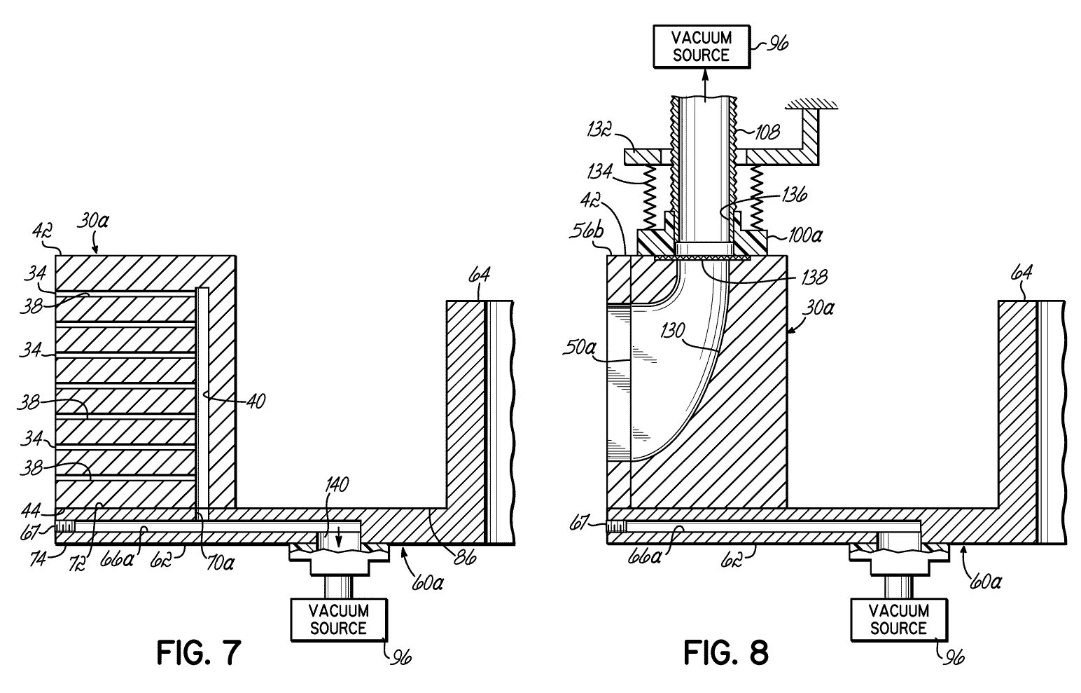

While the embodiments of FIGS. 1-6 have been shown and described herein as including apertures 50 communicating with passages 54 that extend radially through drum body 30 for communication with a second vacuum housing 100 positioned generally within the inner diameter of the drum body 30, the vacuum drum assembly may alternatively have various other configurations to provide vacuum pressure to the first and second apertures 34, 50 in the first and second peripheral surface portions 36, 52 of the drum body 30. For example, FIGS. 7 and 8 depict an exemplary embodiment similar to embodiment discussed above with respect to FIGS. 1-6, wherein similar features have been similarly numbered. In the embodiment shown, passages 130 through drum body 30a extend in a direction toward the first axial end 42 of the drum body 30a for selective communication with a second vacuum housing 100a positioned generally above the first axial end 42 of the drum body 30a. The second vacuum housing 100a is suspended adjacent the first axial end 42 by a bracket 132, or other support structure, and is biased, such as by one or more springs 134, in a direction for contact with the first axial end 42. As the drum body 30a rotates, an aperture 136 on the vacuum housing 100a is brought into registration with the passage 130 to provide communication between second aperture 50a and a vacuum source 96, whereby excess adhesive may be drawn into the second aperture 50a. A screen 138 or other suitable device may be disposed between passage 130 and aperture 136 to prevent the passage of debris or other unwanted material into passage 130 when the second vacuum housing 100a is not positioned over the passage 130.

With continued reference to FIG. 7, the first apertures 34 in the drum 30a communicate with radially extending passages 38 and axially extending bore 40, as described above with respect to FIG. 4. However, axially extending bore 40 communicates with a radially extending bore 66a that in turn communicates with an axial passage 140 extending toward the second axial end 74 of the disk 60a and communicating with the vacuum source 96. It will be appreciated that various other configurations of vacuum drum assemblies are possible to provide vacuum pressure to first and second apertures 34 50a on the outer peripheral surface of a vacuum drum body 30a, and the disclosure is not limited to the specific embodiments shown and described herein.

In another embodiment, second apertures 50, 50a may alternatively be provided in the second peripheral surface portions 36 of a drum body 30, 30a, without providing vacuum pressure to the second apertures 50, 50a. In such an embodiment, excess adhesive may accumulate in the second apertures 50, 50a, even though no vacuum pressure is provided. The accumulated adhesive can be cleaned from the second apertures 50, 50a at desired intervals.

A vacuum drum assembly 16, as described herein, has been demonstrated to provide significant benefits when used in a labeling apparatus. While conventional vacuum drums must generally be removed after about two hours of operation so that excess adhesive can be removed from the vacuum passageways that support labels on the drums, a labeling apparatus having a vacuum drum assembly 16 as described herein has been operated for about six to eight hours without needing to be removed for cleaning or other maintenance. The ability to run for longer periods of time avoids having to shut the labeling equipment down for maintenance and increases production throughput.

A labeling apparatus using a vacuum drum assembly 16 as described herein has also shown increases in labeling efficiency. In particular, the labeling apparatus has been able to run at a consistently high production line speed with fewer defective or rejected labeled products. In one application, the percentage of acceptable labeled products increased from a range of about 75% to about 80% with a conventional vacuum drum, to a range of about 95% to about 98% using a vacuum drum assembly 16 as described herein. It is believed that the ability to maintain high lines speeds while improving the efficiency of acceptable label products is related, at least in part, to several other benefits provided by the vacuum drum assembly 16, such as reduced or eliminated wear on drum pads because of the non-contact design; more consistent volume of glue being applied to the labels; and reduced or eliminated contact between the surface of the vacuum drum assembly 16 and the labels, which might otherwise skew the labels applied to the products.

While the vacuum drum assembly 16 has been described above for use in applying adhesive to labels, it will be appreciated that a vacuum drum assembly as described herein may alternatively be used to apply adhesive to various other flexible substrates. As non-limiting examples, a vacuum drum assembly 16 as described herein could be used to apply adhesive to insulative wrapping material intended to be secured to the outer surfaces of beverage containers, or to apply adhesive to filter material during the manufacture of filters for drinking water or other fluids. Persons skilled in the art will appreciate that vacuum drum assemblies as described herein may be used in various other applications for applying adhesive to flexible substrates.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A vacuum drum, comprising:
a drum body having an outer peripheral surface;
a plurality of first apertures on said outer peripheral surface and in fluid communication with a first vacuum passageway, said plurality of first apertures arranged to define a first area on said outer peripheral surface for receiving and supporting a substrate; and
at least one second aperture on said outer peripheral surface and spaced from said first area, said second aperture in fluid communication with a second vacuum passageway adapted to remove residual adhesive that did not get applied to the substrate.

2. The vacuum drum of claim 1, comprising a plurality of second apertures defining second areas on said outer peripheral surface of said drum body, such that said outer peripheral surface is divided into an alternating series of said first areas and said second areas.

3. The vacuum drum of claim 1, wherein said second aperture comprises an elongate slot.

4. The vacuum drum of claim 1, wherein said first vacuum passageway is adapted to be coupled to a first vacuum source, and the second vacuum passageway is adapted to be coupled to a second vacuum source that is independent of the first vacuum source.

5. The vacuum drum of claim 1, further comprising:
a manifold coupled to said drum body; and
a first passage through said manifold, said first passage in communication with at least one of said first vacuum passageway or said second vacuum passageway.

6. The vacuum drum of claim 1, wherein vacuum pressure applied to said first vacuum passageway is isolated from vacuum pressure applied to said second vacuum passageway.

7. The vacuum drum of claim 1, further comprising:
a first vacuum housing adapted to be coupled to a first vacuum line;
said drum body rotatable relative to said first vacuum housing to selectively place at least some of said first apertures in fluid communication with said first vacuum housing for exposure to the first vacuum line.

8. The vacuum drum of claim 7, further comprising:
a second vacuum housing adapted to be coupled to a second vacuum line;
said drum body rotatable relative to said second vacuum housing to selectively place said second aperture in fluid communication with said second vacuum housing for exposure to the second vacuum line.

9. The vacuum drum of claim 1, further comprising:
an adhesive dispenser proximate said drum body.

10. An apparatus for applying labels to moving articles, the apparatus comprising:
a vacuum drum mounted for rotation about a central axis;
a manifold having a first passage adapted to be in fluid communication with a first vacuum line;
a plurality of first apertures on a first peripheral surface portion of said vacuum drum, said first peripheral surface portion adapted to receive and support a label thereon, said first apertures in fluid communication with said first passage; and
at least one second aperture on a second peripheral surface portion of said vacuum drum, said second peripheral surface portion adjacent said first peripheral surface portion and defining a location behind a trailing edge of a label received on said first peripheral surface portion, said second aperture adapted to be in fluid communication with a second vacuum line adapted to remove excess adhesive applied to the substrate.

11. The apparatus of claim 10, wherein the first vacuum line is associated with a first vacuum source, and the second vacuum line is associated with a second vacuum source that is independent of the first vacuum source.

12. The apparatus of claim 10, further comprising:
an adhesive dispenser proximate said vacuum drum and operable to dispense adhesive to a label supported on said first peripheral surface portion of said vacuum drum.

13. The apparatus of claim 12, wherein said adhesive dispenser is a non-contact adhesive dispensing gun.

14. The apparatus of claim 13, further comprising at least a first sensor target associated with said vacuum drum and adapted to cooperate with a sensor to indicate the location of said first peripheral surface portion relative to said non-contact adhesive dispenser as said vacuum drum rotates relative to said non-contact adhesive dispensing gun.

15. The apparatus of claim 10, wherein said first peripheral surface portion of said vacuum drum is located the same radial distance from a center of the vacuum drum as other portions of said vacuum drum.

16. The apparatus of claim 10, further comprising:
a first vacuum housing defining a second passage adapted to be in communication with the first vacuum line, said second passage in fluid communication with said first passage to thereby provide fluid communication between said first apertures and the first vacuum line.

17. The apparatus of claim 16, further comprising:
a second vacuum housing defining a third passage adapted to be in communication with the second vacuum line, said third passage in fluid communication with said second aperture to thereby provide fluid communication between said second aperture and the second vacuum line.

18. The apparatus of claim 17, wherein at least one of the first or second vacuum housings is stationary relative to said vacuum drum as said drum rotates about said central axis.

19. The apparatus of claim 10, further comprising:
a label feed device proximate said vacuum drum and adapted to feed labels to said first peripheral surface portion of said vacuum drum.

20. A method of dispensing adhesive to a label, comprising:
receiving a label on a vacuum drum;
supporting the label on the vacuum drum using vacuum pressure associated with a first vacuum line;
dispensing adhesive to the label; and
removing residual adhesive that did not get applied to the label using vacuum pressure associated with a second vacuum line.

21. The method of claim 20, further comprising:
developing vacuum pressure in the first vacuum line using a first vacuum source; and
developing vacuum pressure in the second vacuum line using a second vacuum source that is independent of the first vacuum source.

22. The method of claim 20, wherein dispensing adhesive to the label comprises dispensing adhesive without contacting the label.

23. The method of claim 20, further comprising:
transferring the label from the vacuum drum to an object.

24. The method of claim 20, further comprising:
isolating vacuum pressure applied to the first vacuum line from vacuum pressure applied to the second vacuum line.
